(19) United States
(12) Patent Application Publication
(10) Pub. No.: US 2019/0288516 A1
(43) Pub. Date: Sep. 19, 2019

(54) SYSTEM AND METHOD FOR OPERATING A MAINS POWER GRID

(71) Applicant: SUN ELECTRIC DIGITAL STREAM LTD., Road Town, Tortola (VG)

(72) Inventor: Matthew PELOSO, Singapore (SG)

(73) Assignee: SUN ELECTRIC DIGITAL STREAM LTD., Road Town, Tortola (VG)

(21) Appl. No.: 16/349,193

(22) PCT Filed: Nov. 10, 2017
(86) PCT No.: PCT/SG2017/050568

§ 371 Date: May 10, 2019

(30) Foreign Application Priority Data
Nov. 11, 2016 (SG) 10201609493P

(51) Int. Cl. H02J 3/38; H02J 3/28

(52) U.S. Cl. CPC H02J 3/383; H02J 3/28

(57) ABSTRACT

System and system for operating a mains power grid, and system and method for determining a frequency response of a PV generator and/or a frequency response of a thermal storage unit to establish a control routine for controlling power output from the PV generator and/or for controlling power consumption in the thermal storage unit. The method for operating a mains power grid comprises controlling the power output from the one or more photovoltaic (PV) generators coupled to the mains power grid and/or controlling the power consumption in the one or more thermal storage units coupled to the mains power grid based on a characteristic response of the one or more PV generators for curtailment of the power output and a characteristic.

### FIELD OF INVENTION

The present invention relates broadly to a system and method for operating a mains power grid and to a system and method for determining a frequency response of a PV generator and/or a frequency response of a thermal storage unit to establish a control routine for controlling power output from the PV generator and/or for controlling power consumption in the thermal storage unit.

### BACKGROUND

Any mention and/or discussion of prior art throughout the specification should not be considered, in any way, as an admission that this prior art is well known or forms part of common general knowledge in the field.

Renewable energy resources such as photovoltaic generators are becoming more prevalent for installation and connection to a mains power grid. Due to the intermittency of the generators, the power system operator (or in some regions called an independent systems operator or “ISO”) charged with dispatch protocols for stabilization of the supply and demand on the power grid mains portion must account for new supply of generation from sunlight energy converted to AC electrical energy by various photovoltaic arrays connected to the mains power grid.

Power system stability and the supply and demand factors of electricity on a mains power grid have developed utilizing, for example, a dispatchable turbine with thermal combustion and a centripetal mass turning to generate an electric field under a governor control loop. The typical system relies on so called “peaking” generations or “spinning reserves” which are dispatchable and can adjust their outputs in tandem with baseload generators which typically run on full capacity, the former used to track changes in supply and demand and to modify the peaking output so as to establish a stable frequency of the electrical alternating current on the mains power grid. These peaking generators are considered dispatchable in the sense that they can be controlled to increase or decrease their power output characteristics.

On the other hand, renewable power generation such as wind power and solar power, particularly, have been engineered to provide a pure harmonic frequency. As such, these systems do not lead to frequency harmonic changes in their output caused by the relative supply and demand factor on the mains power grid, and traditionally synchronise to the mains power grid frequency. They are, however, considered to be non-dispatchable in the sense that the output of such generators is determined only from the locally available resource, which changes time to time and is nondeterministic. For example, the wind speed or the amount of cloud coverage will make the output of these generators increase or reduce time to time according to the environmental variables. In contrast, with thermal combustion systems, simply modifying the amount of fuel combusted or steam in a turbine is enough to modify the output of the generation system.

To achieve harmony in the introduction of the renewable and non-dispatchable forms of generation with modern power system control, one approach employed is to utilize a system of observing the generation output of the renewable resources, and then using this signal to modify a thermal combustion generator, i.e. as a peaking generator. In this approach, a reading from one form of, what is assumed non-dispatchable, generation is then utilized to control the dispatchable generation resource. In such a system, typically the total output from renewable resources is always maximised, while the thermal combustion resource is modified. However, in such a system, the short time period to react to changes in e.g. wind speed or movement of clouds may lead to circumstances during which the control system becomes unavailable or unable to stabilize the supply and demand on the mains power grid. Additionally, higher charges are typically levied against power generated by the peaking generators, which ultimately have to be borne by consumption customers connecting to the mains power grid for their power supply, or potentially also levied toward those intermittent generators which inevitably leave additional peaking generators on standby in case they must react to intermittency of the renewable power elements due to unpredictable environmental weather behavior

As an alternative control system accounting for the intermittent nature of so-called non-dispatchable resources, storage is often proposed to capture all of the renewable energy resources available, and then to release the energy at times suitable for the needs of power system control. For example, the storage could be released consistently to create a baseload generation response, or could be turned on only during periods of increased demand to counter the need for peaking generator response. However, storage systems that employ chemical batteries are expensive, and have a short life span. These chemical storage systems have a finite number of cycles depending on their depth of discharge characteristics, and as such must be replaced based on the total amount of use. This means that the use of storage systems increases the levelised cost of energy (LCOE) from renewable resources. In addition to this, such storage systems are at risk of exploding or combustion, and are hence dangerous to use at worst, and at best, require stringent maintenance which again adds to the expense and thus the LCOE.

Embodiments of the present invention seek to address at least one of the above problems.

### SUMMARY

In accordance with a first aspect of the present invention there is provided a method for operating a mains power grid is provided, the method comprising controlling the power output from the one or more photovoltaic (PV) generators coupled to the mains power grid and/or controlling the power consumption in the one or more thermal storage units coupled to the mains power grid based on a characteristic response of the one or more PV generators for curtailment of the power output and a characteristic response of the one or more thermal storage units for curtailment of power consumption.

In accordance with a second aspect of the present invention there is provided a method for determining a characteristic response of a PV generator and/or a characteristic response of a thermal storage unit to establish a control routine for controlling power output from the PV generator and/or for controlling power consumption in the thermal storage unit for substantially equalizing the supply and demand of at least a portion of a mains power grid to which the PV generator and/or the thermal storage units are coupled, and/or for substantially equalizing the power output of the one more PV generators and the power consumption of the one or more thermal storage units.

In accordance with a third aspect of the present invention there is provided a system for operating a mains power grid is provided, the system comprising a control unit configured for controlling the power output from the one or more photovoltaic (PV) generators coupled to the mains power grid and/or controlling the power consumption in the one or more thermal storage units coupled to the mains power grid based on a characteristic response of the one or more PV generators for curtailment of the power output and a characteristic response of the one or more thermal storage units for curtailment of power consumption.

In accordance with a fourth aspect of the present invention there is provided a system for determining a characteristic response of a PV generator and/or a characteristic response of a thermal storage unit to establish a control routine for controlling power output from the PV generator and/or for controlling power consumption in the thermal storage unit for substantially equalizing the supply and demand of at least a portion of a mains power grid to which the PV generator and/or the thermal storage units are coupled, and/or for substantially equalizing the power output of the one more PV generators and the power consumption of the one or more thermal storage units.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a schematic drawing illustrating a mains power grid showing incorporation of non-dispatchable generation resources, thermal storage elements, and conventional generation turbines with various points of coupling to the transmission and distribution network, according to an example embodiment.

FIG. 2 shows a schematic drawing illustrating a single photovoltaic generator coupled to the mains power system incorporating a number of electronics units to enable additional control functions internally to the non-dispatchable generation unit, according to an example embodiment.

FIG. 3 shows a schematic drawing illustrating a single node simplification considering a conventional turbine, a PV generator, and a consumption load exemplifying curtailment of output power for power quality stability according to an example embodiment.

FIG. 4a) shows a schematic drawing illustrating a thermal storage system and associates control elements to enable additional control functions internally to the loads driving thermal storage, according to an example embodiment.

FIG. 4b) shows a schematic drawing illustrating a single node simplification considering a conventional turbine, a thermal storage unit, and (another) consumption load exemplifying curtailment of load side demand for power quality stability according to an example embodiment.

FIG. 5 shows a schematic drawing illustrating a single node simplification considering a conventional turbine, a PV generator, a thermal storage unit, and a load exemplifying curtailment of output power and curtailment of load side demand for power quality stability according to an example embodiment.

FIG. 6a) shows a frequency response diagram to assist in stabilizing supply and demand over the mains power grid, according to an example embodiment.

FIG. 6b) shows the photovoltaic generator control associated with the frequency response diagram of FIG. 6a) to assist in stabilizing supply and demand over the mains power grid, according to an example embodiment.

FIG. 7a) shows a frequency response diagram to assist in stabilizing supply and demand over the mains power grid, according to an example embodiment.

FIG. 7b) shows the thermal storage control associated with the frequency response diagram of FIG. 7b) to assist in stabilizing supply and demand over the mains power grid, according to an example embodiment.

FIG. 8 shows a schematic drawing illustrating an aggregated unit of thermal storage systems and photovoltaic generator systems across the proximity of a point of target supply and demand of the electrical mains power grid with associated node portions, according to an example embodiment.

FIG. 9 shows a schematic drawing illustrating the modified supply levels of power demand, and modified baseload power supply factor accounting for the improvement in utilizing control over both dispatchable and non-dispatchable resources generating power and control over load side demand for the electrical power system, according to an example embodiment.

### DETAILED DESCRIPTION OF PREFERRED EMBODIMENTS

Example embodiments described herein provide for implementing and installing a dispatch system over an aggregated assembly of generators, and in particular, for implementation of the dispatch assembly and protocol on, for example, an aggregated array of photovoltaic (PV) generators connected to a mains power grid system. Demand side management implemented over a common thermal storage means is described for additional functionality. The example embodiments seek to enhance the adoption of renewable and intermittent energy for supply in a mains power grid by enabling reactive control systems in thermal storage units and/or a dispatch protocol for intermittent generators that assist in providing output variations from an aggregate of intermittent generators supplying power to a mains power grid and/or variations in a component of loads supplied from the mains power grid, and advantageously selected thermal storage loads having unique temporal properties from which to provide resources for implementing advanced protocols of power grid supply, demand, and stability.

Advantageously, the loads selected comprise a subset of thermal elements which may be adapted to implement thermal storage procedures to avoid or at least reduce inclusion of chemical storage elements.

In one example embodiment, a reactive system that accounts for both the photovoltaic and the peaking power generators' (i.e. including spinning reserves) output is presented. This allows the output of the photovoltaic generators, previously considered as “non-dispatchable” resources, to be dispatched, and thus both intermittent and peaking generators' outputs to be controlled.

Example embodiments seek to establish a system of dispatch of power generation from renewable resources which are intermittent and hence have been considered to be non-dispatchable, while avoiding the additional cost of chemical storage systems. To do so, a system according to one embodiment employs control and governance functions over both non-dispatchable and dispatchable generation means. An information system that engages load response along with active curtailment of renewable generation resources is introduced as a form of short term power storage means in an example embodiment, and is enabled by introducing a thermal storage system utilizing what are already available thermal vessels in common use in cities that demand energy. The system is described, according to an example embodiment, as a system that functions over a plurality of such thermal storage units and e.g. photovoltaic generation units aggregated over a power grid mains unit, with multiple points of coupling into the electrical power mains grid.

Embodiments of the present invention provide a method of controlling the voltage fluctuations in a power grid, the supply and demand factors of energy in an electrical mains power grid, establishing correlations as subsets between consumption and generation to address a subset of supply and demand factors for energy on an electrical power grid, a system of thermal storage allowing a coupled control system accounting for the use of dispatchable peaking generators along with combined thermal storage systems and non-dispatchable intermittent generator resources and an algorithm and process to provide for power system stability and control, a system utilizing a controller and functional set points adapted to maintain energy supply and demand fluctuations to be minimized to a particular interval by utilizing a thermal storage system with a response system, a command protocol for establishing dispatch strings of an aggregation of e.g. photovoltaic generators coupled to the energy power grid at multiple locations, and an implementation of a control method on a set of characteristic loads associated with the intermittent generating facility, and a number of modes of operation of both control and command protocols to serve for various circumstances including environmental circumstances as may be advantageously adapted for a power system operator.

It is understood that the electrical loads and generators are both commonly coupled to a contiguous electrical mains power grid network, and as such, the time information of generation and consumption is precisely characterizing the subsets of generation/loads as associated to the supply and demand factor over the common energy pool of the electrical mains power grid. It can be assumed that electrical voltages travel near to the speed of light, or at a fraction on the order of the speed of light, and as such given the finite distance of a contiguous segment of the electrical power grid network, the association among electrical generation and electrical load meters can be established such as to have a minimal proximity between generation and load so that the transmission loss factor can either be ignored, or minimized and quantified over any particular distance by incorporating study of power grid system infrastructure.

A conventional power grid system with a functioning primary, secondary, and tertiary power system operation scheme and market incorporating generation facilities with governors for providing for frequency control coupling to the power grid is understood by a person skilled in the art. For completeness, reference is made to Handbook of Electrical Power System Dynamics—Modeling, stability, and control, Ed. M. Eremia, M. Shahidehpour, John Wiley & Sons, New Jersey, 2013; Chapters 2 and 6, the contents of which are incorporated by cross-reference.

Conventional power systems operations are equipped to maintain power quality stability substantially by creating control variation in the output of additional generating systems coupled to the electrical mains power grid. The classical output is derived through either kinetic motion of water, or thermal energy of fossil fuels or fission, which convert the energy to mechanical energy that is then in turn converted into electrical energy by synchronous generators. Baseload generation systems are established to provide a constant amount of electrical power through the electrical power system, while additional resources are established typically to serve for variations in the supply and demand factors over the electrical mains power grid.

It is taken that primary, secondary and tertiary markets for supply on the power system can be established, as adopted from the book Eremia, 2013, referenced above.

Reference is made also to WO/2016/167722, which describes methods and systems for operating a plurality of PV generating facilities connected to an electrical power grid network, the contents of which are incorporated by cross-reference.

It is assumed such resources are enabled for the working implementation herein, while additional resources are provided in example embodiments to improve on the power quality factor, including an aggregation of intermittent energy resources utilizing a modified curtailment system as described below, and/or a demand side control scheme implemented over an aggregation of thermal load units.

The purpose of implementing the control schemes as described herein may be to stabilize an electrical frequency, improve power quality, or otherwise to establish for a particular supply and demand factor as may be advantageous for efficient operation of an electrical power network. For example, the control scheme and systems used may allow for different capacity settings among the various generation resources satisfying the electrical demand on the network, or can be implemented to reduce the requirement of spinning reserves on an electrical mains power grid by synchronizing load demand events along with power generation events without the requirement of utilizing chemical storage units, or at least with a reduction in utilizing chemical storage units.

The present specification also discloses apparatus for implementing or performing the operations of the methods. Such apparatus may be specially constructed for the required purposes, or may comprise a device selectively activated or reconfigured by a computer program stored in the device. Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a device. The computer readable medium may also include a hard-wired medium such as exemplified in the Internet system, or wireless medium such as exemplified in the GSM, or 3/4G mobile telephone system. The computer program when loaded and executed on the device effectively results in an apparatus that implements the steps of the method.

The invention may also be implemented as hardware modules. More particular, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the system can also be implemented as a combination of hardware and software modules.

In the following, preferred embodiments of infrastructure components will be described.

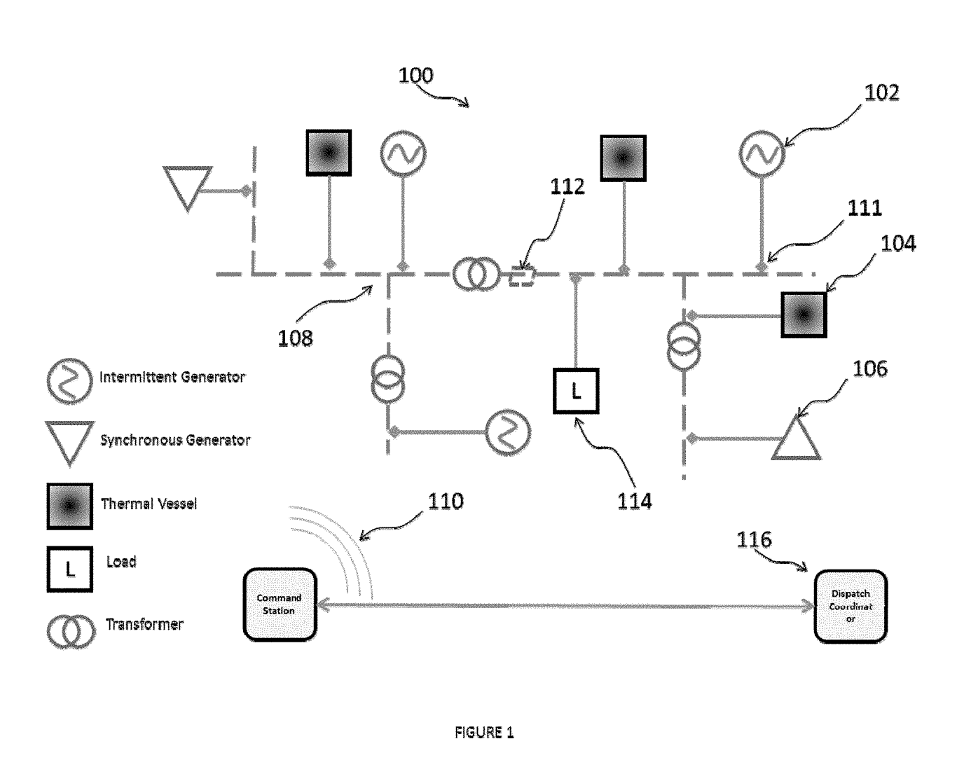

FIG. 1 shows a schematic drawing illustrating a mains power grid 100 showing incorporation of non-dispatchable generation resources e.g. 102, thermal storage elements e.g. 104, and conventional generation turbines e.g. 106 with various points of coupling to the transmission and distribution network 108. In the following, control systems for use with non-dispatchable generation resources e.g. 102 according to example embodiments will be described.

For the effective control of non-dispatchable generation resources e.g. 102 such as photovoltaic generating units, one or more central server and communication units 110 (also referred to as a server command station herein) are installed in example embodiments to effect or instruct control to each individual non-dispatchable generation resources e.g. 102, while a programmable logic controller (PLC) is equipped locally at each non-dispatchable generation resources e.g. 102. Incorporated within the server command station 110 according to an example embodiment are a communication interface to send and receive encrypted and certified communications compatible with a virtual private network (VPN) router installed among various PV generators or thermal storage units actively interfaced with the electrical power grid which enables communication among the units as well as communications from a dispatch coordinator 116 to the PV generators and thermal storage unit devices. Moreover, this server command station 110 is equipped with a central processing unit (CPU) and logic systems to perform computations.

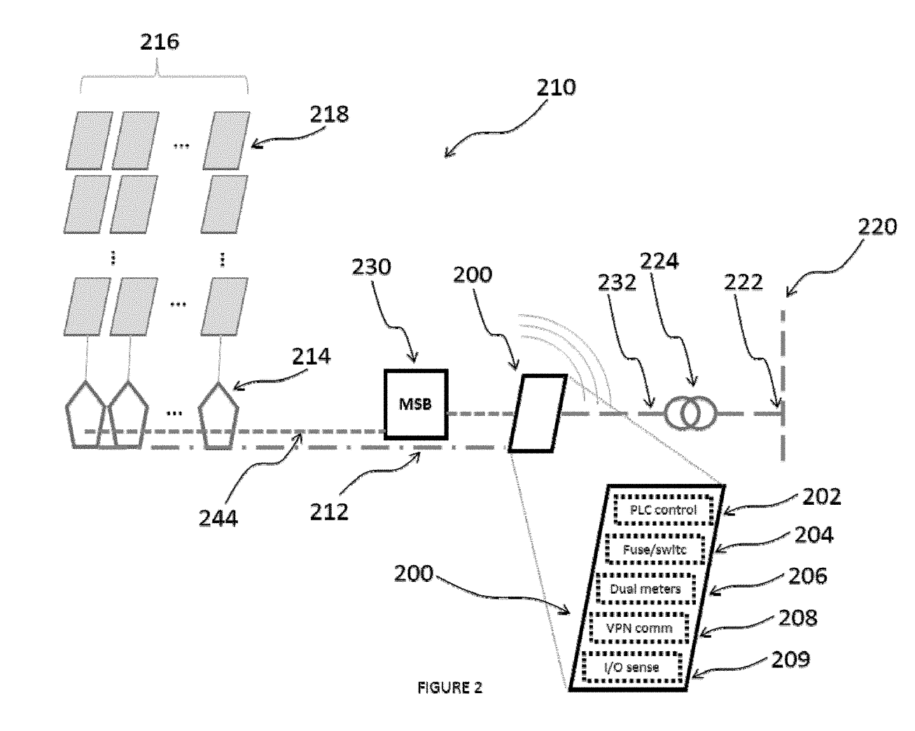

As shown in FIG. 2, a control unit 200 enabled with a PLC 202, switchgear 204, dual metering 206, virtual private network (VPN) router 208 and Analogue or Digital in-out (I/O) system 209 for incorporation of electronics signals and sensors is provided at each local non-dispatchable generation resources, e.g. a photovoltaic generator 210 to enable communications and commands, via communication line(s) 212, to the inverters e.g. 214 of each photovoltaic generating array e.g. 216, comprising interconnected solar panels e.g. 218. The photovoltaic generator 210 is coupled to a mains power grid 220 at an associated point of coupling 222 or 232 (whereat which electronic signal sense can be incorporated), through to distribution or transmission networks of various voltages among the mains power grid 220 e.g. via a transformer or substation 224. Main switch board (MSB) 230 includes electrical combiner electronics and switchgear functioning to incorporate the accumulated energy along electrical cables 244 of the inverters e.g. 214 output from the photovoltaic generator array 216 to a combined power output cable 232 to point of common coupling 222, and can include remote switches for additional control routines. The control unit 200 sends and receives information from both the MSB 230 switchgear, as well as directly to the inverter elements 214. This allows for the collection of the state of the MSB 230 or the inverter elements 214 as well as for sending control procedures or settings to those apparatus.

It would be appreciated by a person skilled in the art that the direct connection to the mains power grid demonstrated in FIG. 2 is an embodiment, while an indirect connection scheme can be utilized such that the point of common coupling is introduced downstream from the PV generator 210 within a separate circuit itself coupled to the mains power grid. Whereas in a direct connection frequency events on the mains power grid can be sensed at any local PV generator (compare PV generator 102, FIG. 1), with an indirect connection scheme, the sensing of frequency events on the mains power grid may be diminished, but control to the PV generator from the server command station (compare 110, FIG. 1) according to an example embodiment can still control the power stability by way of supply demand characteristics at the point of common coupling 222 or 232 (depending on the connection voltage) of the indirect circuit connection to the mains power grid. Alternatively, a sensor at the point of common coupling of said separate circuit may be installed to advantageously send signals read from the point of common coupling of said separate circuit to the local PV generator installed between the local PV generator and the electrical mains power grid.

Reference is made to e.g. WO 2016/032396 A1, the contents of which are incorporated by cross-reference, for a description of connection options of PV generators to a mains power grid, to which embodiments of the present invention may be applied.

Returning to FIG. 1, preferably, the entire specification list of each non-dispatchable generation resource is stored both locally and at the server command station 110. Utilizing information from the specification list, such as the power capacity, commands for curtailment of energy generation and/or load curtailment can be implemented by obtaining a local signal such as a voltage, frequency, or current detection at a local point of common coupling e.g. 111 of the non-dispatchable generation resource e.g. 102, or from the server command station 110. Additionally, energy generation and/or load curtailment can be implemented using a communication signal of the server command station 110, or a communication signal of a PV e.g. 102 or set of PV generators installed within the mains power grid 100 network.

Information representing the nodal supply and demand factors as associated with various locations on the transmission and distribution network 108 of the electrical mains power grid 100 are accessible to the server command station 110 and as such to the local non-dispatchable generation resource e.g. 102. In addition, electrical tension is defined herein by way of associating each non-dispatchable generation resource e.g. 102 to the local point of common coupling to the transmission and distribution network 108 of the mains power grid 100 and the equivalent electrical distance to a target node or point of target supply and demand, e.g. 112 to a load or loads e.g. 114, within the electrical mains power grid 100.

By manner of control through the server command station 110, or performed at the local non-dispatchable generation resource e.g. 102 (utilized with the local control unit implementation described at FIG. 2), e.g. an individual photovoltaic (PV) generating unit, or a set of target PV generating units can be curtailed in their power output by a quantifiable amount as computed from any of the detected electrical information at the point of common coupling of the photovoltaic generating unit on the transmission and distribution network 108 of the electrical power grid 100, or the nodal supply and demand as obtained or measured at the server command station 110, so as to provide for stability of the electrical power quality on the electrical mains power grid 100.

The enablement of curtailment of electrical power output from non-dispatchable generation resources, such as a photovoltaic generating unit, as described above provides for a reduction of generation or supply of electrical energy to a particular region of the electrical power grid 100. Thus, this resource, in tandem with control governors or dispatch coordinator 116 of conventional turbine(s) or through control procedures as adopted over a primary, secondary, or tertiary supply, can provide a control that may stabilize power quality by shifting the supply of energy downward to temporarily eliminate the overcapacity of energy on the mains power grid and in turn reduce the frequency of acceleration events of the synchronous generators (including of the peaking generators) on the electrical frequency of the mains power grid 100, as associated to a particular node e.g. 112 on the transmission and distribution network 108. In such a scenario, the PV generator(s) form a component of spinning reserve capacity such that peaking synchronous generators are able to be utilized less frequently, or potentially turned off.

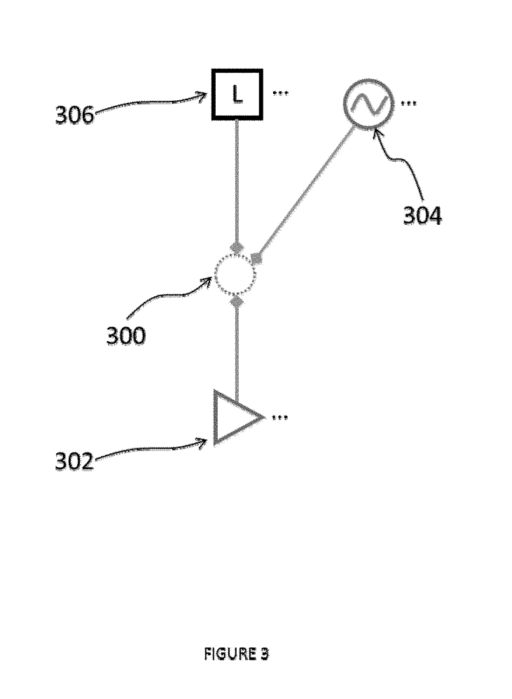

As illustrated in FIG. 3, in a single node 300 simplification, a conventional turbine or set of conventional turbines 302, which may represent a spinning reserve, or otherwise, a generator to serve to primary, secondary or tertiary demand, a PV generator or set of PV generators 304, and a consumption load or set of consumption loads 306 may be considered. The consumption load 306 is considered to require a certain demand, which is met by certain operation conditions of the turbine 302 and the PV generator(s) 304, which together provide the supply at the node 300, for supply and demand pairing at the node 300. If the demand by the load(s) 306 experiences a sudden decrease for any reason, in addition to or as an alternative to control of the turbine 302 to decelerate, the inverter(s) (not shown) at the PV generator(s) 304 can be controlled to reduce the supply at the node 300, thus stabilizing power quality. As will be appreciated by a person skilled in the art, the control of the power output of the PV generator(s) 304 can occur on a faster response time compared to the turbine. This can e.g. avoid, or at least reduce the chance of, power failure due to safety mechanisms imposed in typical mains power grids based on power quality measures. It is noted that while it may be preferred to operate the PV generator(s) 304 at full capacity under “normal” conditions, and to only use a control to reduce power output if needed, it would nevertheless also be possible to operate the PV generator(s) 304 at a certain percentage of maximum output, to enable both output power reduction and increase control options in different embodiments. This would allow shifting the supply of energy from PV generator(s) 304 upward to create an additional supply as may be required if the load(s) 306 experience a sudden increase in demand. In the event that both conventional generation 302 and PV generator(s) 304 together are required to establish for the proportional power shift in the load(s) 306, and proportional upshift in the electrical output of the turbine 302 results from stabilizing the electrical power grid network node 300 for a combination of load(s) 302.

Returning to FIG. 1, additionally or alternatively, thermal storage units e.g. 104, which may conventionally be considered merely as part of the consumption load on the mains power grid, have been recognized by the inventors as a potential resource from which the frequency response stability can be implemented, and which are e.g. cheaper than chemical storage units. As recognized by the inventors and described herein, thermal storage is not the storage of energy (in heat) as such, but rather the presence of a cool or cold reservoir accessible for providing time shifting of energy usage by providing a reservoir from which thermal heat can flow. Reference is made to “Sustainable Thermal Storage Systems” Lucas Hyman, Lucas B. Hyman, 2011, Chapters 4 and 5, the contents of which are incorporated by cross-reference. One potential and predominantly present resource that may be used for thermal storage are air-conditioned buildings. High voltage air conditioning (HVAC) units are commonly coupled to the electrical mains power grid 100 to cool buildings, which act as thermal storage vessels with specifications comprised of the thermal conductivity of their material walls, geometrical configurations, fluid flows, and volume of fluid (air) within the buildings.

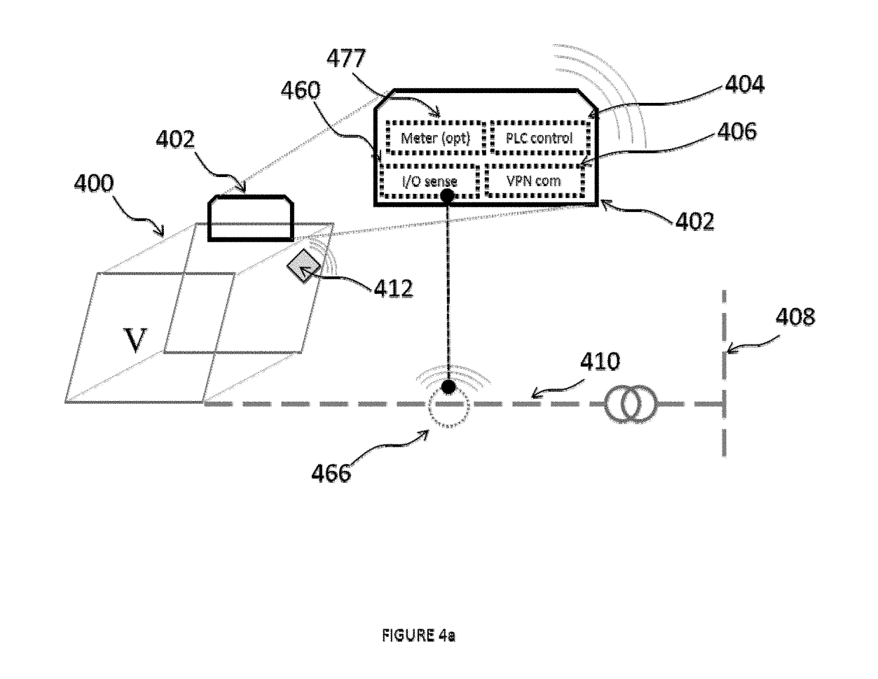

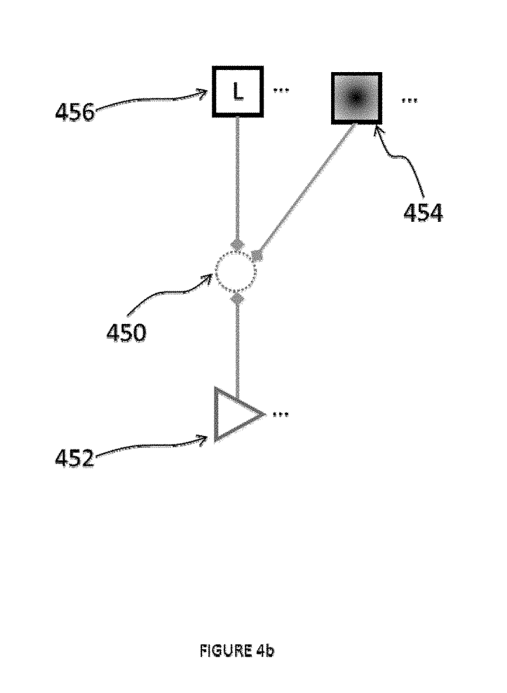

As illustrated in FIG. 4a), a building 400 the internal thermal environment of which is regulated using one or more HVAC units 402, equipped with a controller 404 and VPN communication router 406, digital or analogue in/out (I/O) sensory module 460, and optional electrical metering 477, functions as a storage vessel by virtue of its internal volume V according to example embodiments. The HVAC units 402 are connected as controllable loads coupled to a mains power grid 408 at an associated point of coupling 410. A dedicated temperature measurement unit 412 equipped with a VPN communication router or enabled to communication to HVAC unit 402 through I/O sense unit 460 connected with VPN communication unit 402 is provided to facilitate control of the HVAC units 402 such that power consumption can be regulated to provide desired frequency response stability, while maintaining the temperature in the building 400 within a tolerated or desired range or set points. Advantageously, remote signals can be implemented for control of the HVAC units 402 though the command station 110 (FIG. 1), or a local measurement of the electrical power mains for example at or through a metering circuit installed in the building in which the HVAC units 402 are installed to communicate from the point of common coupling of the electrical power grid to the HVAC units 402, for example through sensing electrical voltage and frequency events at point of coupling 410 through sensor 466 equipped to communicate to HVAC units 402.

As illustrated in FIG. 4b), in a single node 450 simplification, a conventional turbine or set of conventional turbines 452, which may represent a spinning reserve, or otherwise, a generator to serve to primary, secondary or tertiary demand, a thermal storage unit or set of thermal storage units 454, and (another) consumption load 456, which may represent one or more other consumer loads. The consumption load 456 is considered to require a certain demand, which is met by certain operation conditions of the turbine 452 and the thermal storage unit(s) 454, which together provide the supply at the node 450, for the supply and demand pairing at the node 450. If the demand by the load 456 experiences a sudden decrease for any reason, in addition to or as an alternative to control of the turbine 452 to decelerate, the thermal storage unit(s) 454 can be controlled to increase their power consumption which in turn increases the demand at the node 450, thus stabilizing power quality. As will be appreciated by a person skilled in the art, the control of the power output of the thermal storage unit(s) 304 can occur on a faster response time compared to the turbine 452. This can e.g. avoid, or at least reduce the chance of, power failure due to safety mechanisms imposed in typical mains power grids based on power quality measures. If, on the other hand, the demand by the load 456 experiences a sudden increase for any reason, in addition to or as an alternative to control of the turbine 452 to accelerate, the thermal storage unit(s) 454 can be controlled to decrease their power consumption and thus demand at the node 450, thus stabilizing power quality. This, in effect, would allow shifting the supply of energy upward to create an upshift in the electrical frequency of the electrical mains power grid.

Returning to FIG. 1, for the purpose of providing a stability function, an aggregation of HVAC units as part of thermal storage units e.g. 104 coupled to the transmission and distribution network 108 of the electrical mains power grid 100 can be controlled to adapt the output of these HVAC units in association with specifications of the thermal storage units e.g. 104. The server command station 110 with which control procedures to the non-dispatchable generation resources e.g. 102 may be established can be used to perform control procedures for implementing thus, not only either energy curtailment of PV units e.g. 102 or load curtailment of the HVAC units of thermal storage units e.g. 104, but both energy curtailment of PV units e.g. 102 and load curtailment procedures upon the HVAC units of thermal storage units e.g. 104 incorporating the combined effect of said HVAC and PV generating units on the power quality, supply and demand factor, or frequency stability of the mains power grid. Notably, thermal storage units e.g. 104 specifications uploaded in the local database or the remote server command station 110 allow for the quantification of total thermal storage, and the conductivity of the thermal storage vessel such that the time decay of thermal energy storage can be implemented to advantageously ensure that operation of the thermal storage units e.g. 104 can be performed in a manner through which the building's internal temperature is maintained within a specific range (e.g. from 22-23 degrees Celsius).

As illustrated in FIG. 5, in a single node 500 simplification, a conventional turbine 502, which may represent a spinning reserve, or otherwise, a generator to serve to primary, secondary or tertiary demand (book Eremia, 2013, referenced above), a PV generator or set of generators 504, a thermal storage unit or set of thermal storage units 507 and (another) consumption load 506, which may represent one or more other consumer loads, may be considered. The load 506 and the thermal storage unit(s) 507, i.e. the HVAC units (not shown) in one or more building (not shown) under normal operating conditions are considered to, together, require a certain demand, which is met by certain operation conditions of the turbine 502 and the PV generator(s) 504, which together provide the supply of the supply and demand pairing at the node 500. If the demand by the load 506 experiences a sudden decrease for any reason, in addition to or as an alternative to control of the turbine 502 to decelerate, the inverter(s) (not shown) at the PV generator(s) 504 can be controlled to reduce the supply at the node 500, thus stabilizing power quality. As will be appreciated by a person skilled in the art, the control of the power output of the PV generator(s) 504 can occur on a faster response time compared to the turbine. This can e.g. avoid, or at least reduce the chance of, power failure due to safety mechanisms imposed in typical mains power grids based on power quality measures. Additionally, if the load 506 experiences a sudden increase in demand, the HVAC units (not shown) in one or more building (not shown) constituting the thermal storage unit(s) 507 can be controlled to reduce power consumption, e.g. by temporally switching off a subset of the HVAC units within the building(s)/thermal reservoir(s). This allows decreasing the overall demand at the node 500 to create an upshift in the electrical frequency of the electrical mains power grid by association with a limited set of PV generator(s) 504 or thermal storage unit(s) 507, while preferably maintaining output from the PV generator(s) 504 at a maximum.

It is noted that optionally, batteries (not shown) can still be used for shifting the time use of energy from the PV generator(s) in the systems described above with reference to FIGS. 3, 4b) and 5, but can advantageously be reduced in size. Moreover, electric vehicles battery charging stations coupled to the electrical mains power grid could advantageously provide for a chemical storage resource in lieu of dedicated electrical power storage components, which can allow for the advantageous control of current drawn into the electrical vehicle charging stations so as to address periods of electrical supply shortfalls, or electrical generation overloads.

In such systems according to example embodiments, it is possible to utilize combined thermal storage units and PV generators control functionality to assist in providing a combined spinning reserve reducing or eliminating the requirement of synchronous generators providing this function.

Returning to FIG. 1, through provision of the above described control procedures adopted over an aggregation of thermal storage units e.g. 104 coupled to the transmission and distribution network 108 of the electrical mains power grid 100, and preferably in tandem with the above described control procedures adopted over an aggregation of non-dispatchable generation resources e.g. 102, stability of the electrical mains power grid 100 can advantageously be performed by utilizing curtailment of energy generation from various e.g. photovoltaic generating units, and curtailment of HVAC load from various grid connected HVAC load units. In combination, short term fluctuations can be implemented to either shift the electrical power frequency up or down relative to the thermal combustion output via the primary, secondary, or tertiary energy market by way of controlling power output of peaking generation facilities such as turbines 106 conventionally utilized under the dispatch coordinator 116 as control governors, while incorporating control features for stabilizing temporal supply and demand at an associated point of the transmission and distribution network 108 to an aggregation of both non-dispatchable generation resources e.g. 102, and HVACs of thermal storage units e.g. 104 whose output/consumption respectively can be modified actively along with a dispatch routine from the dispatch coordinator 116. In so doing, the dispatch coordinator 116 may provide to selected units mode of operation settings configured according to energy supply and demand events as well as external factors such as environmental behavior or weather patterns.

Any active curtailment of the HVACs of thermal storage units e.g. 104 is preferably performed by quantifying the temperature coefficients of the storage means (cool reservoir) from a temporal perspective, and maintaining any reduction in the HVAC load such that the level of cool air or the temperature of the fluid volume within the building at no time crosses a particular thermal boundary. In this way, control procedures can be preferably be performed so as to maintain the temperature of a building. An additional benefit of such embodiments is that active instead of passive demand side management procedures can be implemented in a manner in which the electrical consumer is not impacted in the quality of service, by way of experiencing hotter or colder environment within their buildings, given that all HVAC curtailment is preferably performed while maintaining the temperature set point within each individual storage means (cool reservoir). Moreover, so that the electrical consumption can be maintained to keep the volume V within a certain range of temperature in any given thermal storage means, multiple thermal storage units each individually providing for a limited amount of electrical demand curtailment within any particular interval of time can be implemented.

In the following, computation of frequency shifts and determined response of Power System Operation (PSO) according to example embodiments will be described.

The droop method (book Eremia, 2013, referenced above) is commonly adopted for governor control of frequency on an electrical mains power grid. This system quantifies the linear response among frequency shifts in respect of acceleration and deceleration of combustible turbines connected to the electrical power grid.

In example embodiments described herein, the output of peaking or dispatchable generators is controlled in tandem with a system of modified supply and demand utilizing both curtailment of non-dispatchable generation resources' output and curtailment of thermal storage units so as to provide both a relative frequency shift upward by curtailing at least one thermal load such as an HVAC unit associated with a particular nodal supply and demand on the electrical mains grid or a relative frequency shift downward by curtailing at least one generating facility associated with a particular nodal supply and demand on the electrical mains grid.

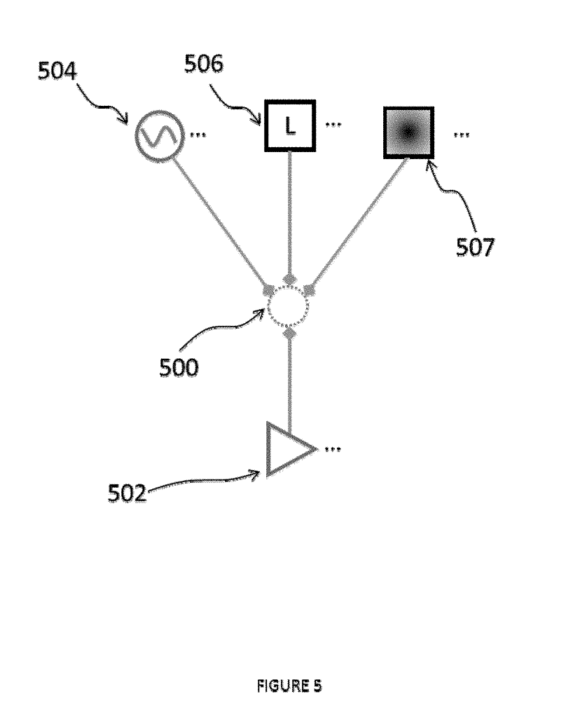

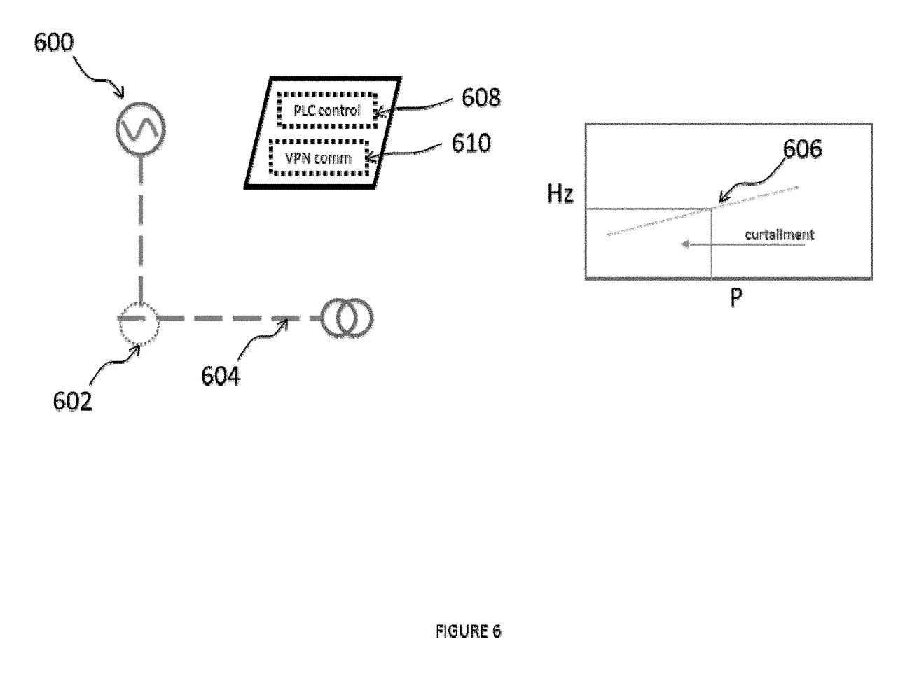

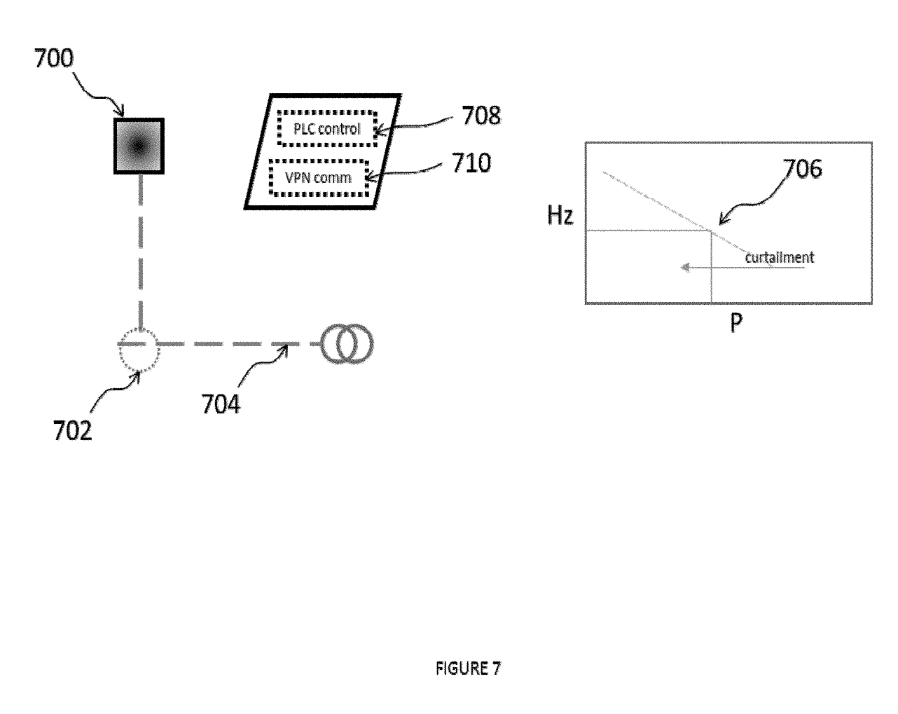

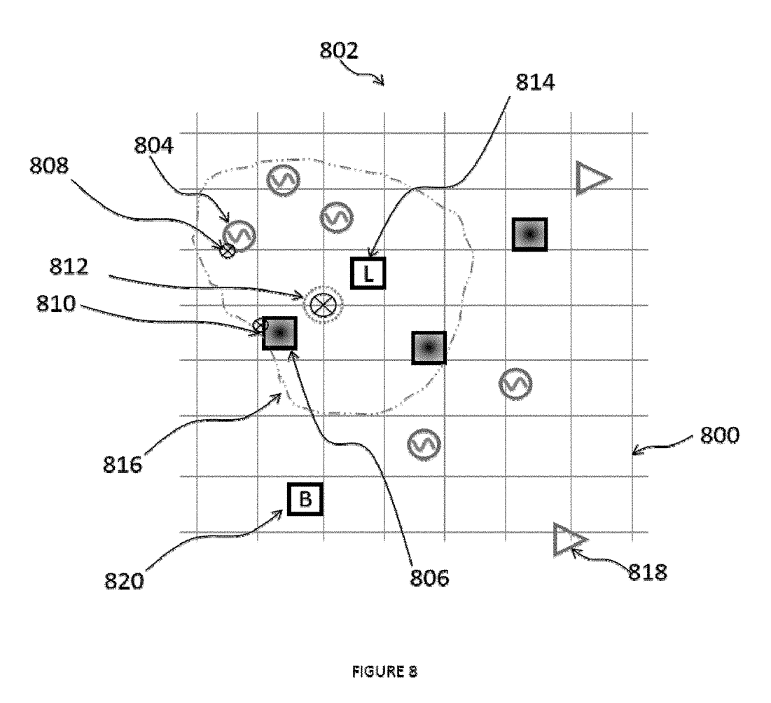

Characteristics for implementing said procedures include collecting and utilizing specifications of the electrical mains grid electrical transmission and distribution characteristics and the electrical tension between each aggregated non-dispatchable generation resources and/or thermal storage unit, the specifications of each non-dispatchable generation resource, and the specifications of each thermal storage unit. As will be appreciated by a person skilled in the art, a characteristic response of the non-dispatchable generation resource or aggregation of resources for curtailment of the associated power output and a characteristic response of the thermal storage units or aggregation of units for curtailment of power consumption can be determined in different ways, an example of which will be described below with reference to FIGS. 6 and 7.

As illustrated in FIGS. 6 a) and b), e.g. for each PV unit/aggregated PV unit 600 relevant to a particular point of coupling 602 on a transmission and distribution network 604, a linear response 606 among the frequency shift for a curtailment of PV power output can be determined to counter frequency increase for surplus-supply conditions, with curtailment controlled via PLC 608 and VPN router 610 equipped PV unit/aggregated PV unit 600. Similarly, as illustrated in FIGS. 7 a) and b), for each thermal storage unit/aggregated thermal storage unit 700 relevant to a particular point of coupling 702 on a transmission and distribution network 704, a linear response 706 among the frequency shift for a curtailment of HVAC load can be determined to counter frequency decrease for under-supply conditions, with curtailment controlled via PLC 708 and VPN router 710 equipped HVAC units of the thermal storage unit/aggregated thermal storage unit 700. This linearization can allow for the command control center server command station to establish for a particular aggregation of units (thermal or PV) what the quantified curtailment should be, by way of either communicating a particular change to those units (in a master mode) or by setting an operating mode among the selected units such that those units perform a specified curtailment amount in response to a locally detected frequency shift at the point of common coupling to the electrical power grid network (in a slave mode), as will be described for example embodiments in more detail below.

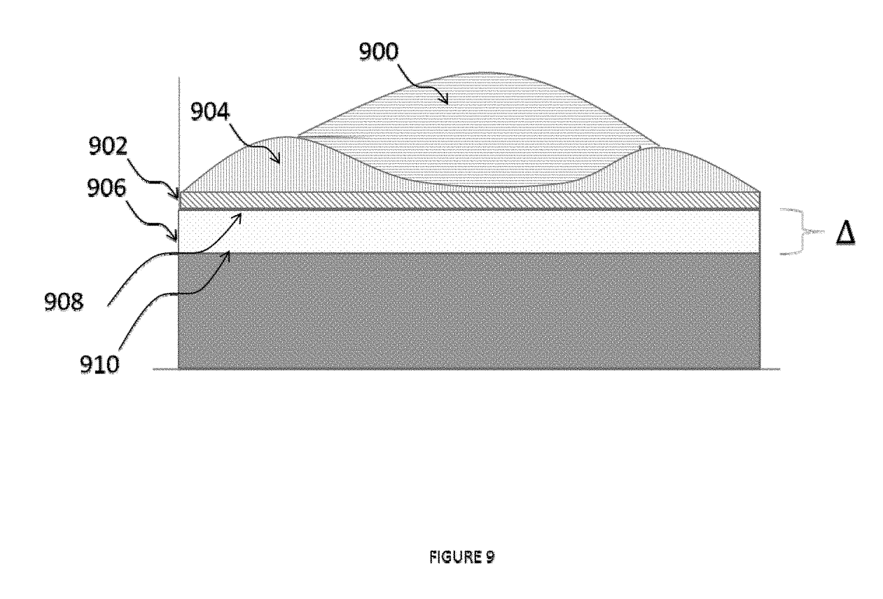

FIG. 8 shows a schematic drawing illustrating a nodal representation of a transmission and distribution network 800 of a mains power grid 802, for example across a city environment. Preferably, the entire specification list of each non-dispatchable generation resource e.g. 804 and each thermal storage unit e.g. 806 is stored both locally and at a server command station (not shown). Utilizing information from the specification list, such as the power capacity, commands for curtailment of energy generation can be implemented by obtaining a local signal such as a voltage, frequency, or current detection at a local point of common coupling e.g. 808 of a non-dispatchable generation resource e.g. 804 and/or of common coupling 810 of a thermal storage unit e.g. 806, or from the server command station.

Information representing the nodal supply and demand factors as associated with various locations on the transmission and distribution network 800 of the electrical mains power grid 802 are accessible to the server command station and as such to the local non-dispatchable generation resources e.g. 804 and the thermal storage units e.g. 806. In addition, electrical tension is defined herein by way of associating each non-dispatchable generation resource e.g. 804 and each thermal storage unit 806 to the local point of common coupling e.g. 808, 810 to the transmission and distribution network 800 of the mains power grid 802 and the equivalent electrical distance to a target node or point 812 of target supply and demand to a load or loads e.g. 814, within the electrical mains power grid 802. For example, a subset 816 of non-dispatchable resources and thermal storage units may be selected for the point 812 of a target supply and demand to be controlled according to the curtailment of output power and curtailment of HVAC load as described above, optionally in conjunction with governor control of peaking generators e.g. 818 and/or batteries e.g. 820 proximate to the point 812 of the target supply and demand.

The control system according to example embodiments can be implemented by utilizing measurements of intermittency at the aggregated capacity of non-dispatchable resources (PV generators) and the quantified thermal storage e.g. 806 capacity to introduce curtailment of e.g. the HVAC units at the aggregated capacity of thermal storage units e.g. 806 through a communication network and utilizing the server command station (compare 110 in FIG. 1) independent of detected frequency events on the network 800, in a manner so as to equalize the associated supply and demand of combined aggregated capacity of PV non-dispatchable resources and thermal storage units; or the control system according to example embodiments can be implemented using detection of frequency shifts on the power grid network 800 (representing supply and demand mismatch by reference to the acceleration or deceleration of synchronous turbines) as the trigger for curtailment of the PV generators 804 or thermal storage units 806. Advantageously, the signal utilized (in one case being the measured output of energy by the intermittent PV generators 804) can be replaced or supplemented with an irradiance sensor or relevant meteorological sensor to trigger active demand management over the aggregated PV generators and/or thermal storage units.

Given this system architecture according to example embodiments, the method of associating a selected set of thermal storage units and/or PV generator units can be established among various modes of operation, as mentioned above. These modes of operation lead to various dynamic performance settings of the whole system. For example, in a master mode, the server command station is enabled to control actively the various curtailments of selected units, irrespective of detected frequency harmonics by those units at a point of coupling at the power grid. In a slave mode, those units can be set to a mode wherein they react quantifiably accounting for the amount of curtailment to be performed in response to a particular harmonic frequency event as detected locally.

In the slave mode, the server command station advantageously may compute and establish for such quantifiable curtailment amount by factoring in the total number and kind of units utilized to perform the control procedure and providing boundary conditions such as scaled response functions for individual units so that the desired quantifiable curtailment is achievable over the aggregate of the individual units' responses. Advantageously, this allows the dispatch coordinator to enter master mode where it detects or predicts a level of supply and demand mismatch as from observed behavior of consumers and suppliers of electricity to a power market, where they can still provide for a slave mode operation which provides that frequency detection events allow reactive control to occur at the individual PV generators or thermal storage units selected in proximity to a specific node of an electrical power grid.

In addition, advantageously, the PV and thermal storage units can operate in a equalized mode wherein they are responsive to equalize their own associated supply and demand such that the independent operation of these aggregated PV generators and thermal storage units can allow the remaining governor system to be operated on the power grid network independently of this active demand management system, but by incorporating the associated reduction of capacities aggregated among the PV generators and thermal storage units.

Returning to the slave mode, the command station 110 (FIG. 1) which includes a CPU in an example embodiment can implement calculations for the various gain settings among the selected control units among both PV generator(s) and thermal storage unit(s) such that the Proportional, Integral, or Derivative (PID) control settings are established to provide for the instantaneous response relative to the total number of selected units in proximity to a particular node (or set of nodes). Similarly, the proper characteristic settings of the control system can be computed and established for a Proportional, Differential; Proportional, Integral, or other implementation.

Moreover, to establish for reactivity of the distributed PV generator(s) and thermal storage unit(s), the command station 110 can send default settings or pre-calculated settings to the individual units to be stored and implemented under specific characteristics or events established for various selected subsets of controllable devices, namely PV generator(s) or thermal storage unit(s) on the electrical power grid.

In the following, modified baseload power settings and revised primary, secondary, and tertiary supply pools according to example embodiments will be described.

Computation of a baseload requirement is typically performed to reduce the baseload setting on the electrical mains grid. As illustrated in FIG. 9, by enabling curtailment of non-dispatchable resources, e.g. PV supply and reaction portion 900 during daytime periods, and curtailment of load side demand by thermal storage units, providing a thermal curtailment reaction portion 902, according to example embodiments, along with an active primary, secondary and tertiary supply and demand control scheme e.g. over peaking generators 904, 906, additional energy resources from non-dispatchable resources can be used to preferably reduce the need for baseload power, as illustrated by A baseload between baseload lines 908, 910.

An additional benefit of this system is that any chemical storage means such as batteries that are used for shifting the time use of energy from non-dispatchable resources, which are expensive devices and create additional conversion losses when implemented, can be reduced in size and/or replaced with much cheaper storage means which are simply the volume of air within various buildings which are already connected to the electrical mains power grid and utilizing HVAC loads which can be actively controlled, according to example embodiments.

If this above system is coupled with an electrical storage system for vehicles which can be used to place storage batteries into cars, the current drawn into batteries can be controlled to create for an additional power stability resource through the electrical network.

Although the embodiments of the present invention have been described in the context of controlling curtailment of HVAC or PV generator units in association to a mains power grid, it will be appreciated by a person skilled in the art that the server command station can be configured in addition to account for electric vehicle storage charging as a load that can be accounted for as an additional resource utilized to accurately draw power from the mains power grid. In particular, when there is a surplus production (e.g. from surplus PV generation) drawing power for vehicle storage charging can be increased and as such reducing the requirement for the active curtailment of PV production of electricity at those times, or when there is a reduced thermal load utilization on the HVAC units.

In the following, preferred embodiments of dynamic system settings will be described by way of example.

Various operational modes or settings for implementing control and dispatch routines among both dispatchable PV generators equipped with advanced hardware functions and thermal storage units, as described above, may be implemented. These can be performed by way of establishing control procedures to either take input from the remote server command station 110 (FIG. 1), or from their local sense reading inputs, as may be established by issuing command settings from the server command station 110 (FIG. 1).

They may also be implemented over a group of the PV generators or thermal storage units, or can be implemented at individual PV generators or thermal storage units. In example embodiments, the control and dispatch routines may be performed only on PV generating units and peaking (spinning) reserves, or for thermal storage procedures only on thermal storage units in combination with PV generating units, or utilizing all of the peaking reserves, PV generating unit, and thermal storage units.

As can be appreciated from a meteorological perspective, PV electrical production events are not random, but are generally reproducible in a stochastic manner in association with a particular weather pattern. For example, should there be no cloud coverage, the actual performance output of a PV generator is fairly deterministic, and as such a common mode for utilization wherein it is known that no cloud coverage would occur can be developed with a reduced spinning reserve requirement given that the total production of generation is determined.

In the same sense, where persistent cloud coverage is known to likely occur during a future period of time, the predictable minimized output curve from the PV generator as associated with the diffuse collection of photovoltaic cells can be used to determine the PV generation electricity contributed to the electrical mains power grid. As such, during these two kinds of weather events, the system may operate under a mode where the need for back up spinning reserves is reduced given the predictable nature of PV generator(s) output within time periods on the scale of a fraction of a day or a few days, relative to the start-up time of a conventional generator being used to establish the capacity of a spinning reserve requirement.

When cloud coverage becomes scattered or intermittent, the PV generator electrical production can jump between maximum to minimum output stochastically, and as such an increased spinning reserve requirement may conventionally result. However, utilizing the advanced control procedures according to example embodiments described herein can advantageously reduce the need for back up spinning reserves even under such weather conditions.

During the periods of significant intermittency of solar power output, the server command station can produce the curtailment units (both PV generators and thermal storage units) to behave in a more active setting. Preferably, given that a master mode control as described above according to example embodiments may be unable to predict for the power shifts on the mains power grid due to the intermittent cloud coverage events, a system which utilizes local sensing of frequency events on the network in a slave mode as described above according to example embodiments can be used to, for example, implement the curtailment of PV generator production temporarily for the required reductions of PV power output to the electrical mains power grid during events of over supply due to an increase in PV generator(s) output or a decrease in electrical power consumed at load(s).

In one embodiment a method for operating a mains power grid is provided, the method comprising controlling the power output from the one or more photovoltaic (PV) generators coupled to the mains power grid and/or controlling the power consumption in the one or more thermal storage units coupled to the mains power grid based on a characteristic response of the one or more PV generators for curtailment of the power output and a characteristic response of the one or more thermal storage units for curtailment of power consumption.

Each thermal storage unit may comprise a building with one or more associated air conditioners and controlling each thermal storage unit may comprise a curtailment of at least one of the one or more associated air conditioners.

The method may be implemented to substantially equalize the power output of the one more PV generators and the power consumption of the one or more thermal storage units.

The controlling of the one or more thermal storage units may be responsive to a measured intermittency of selected ones of the one or more PV generators.

The controlling of the one or more PV generators and/or the one or more thermal storage units may be responsive to a change in a supply and demand characteristic of at least a portion of the mains power grid. The method may comprise determining the change in the supply and demand characteristic by locally sensing a change in frequency on the mains power grid at respective points of coupling of the PV generators and/or locally at respective points of coupling of the thermal storage units, and locally controlling the PV generators and/or the thermal storage units. The method may comprise determining the change in the supply and demand characteristic by sensing a frequency on the mains power grid at respective points of coupling of the PV generators remotely and/or at respective points of coupling of the thermal storage units remotely, and remotely controlling the PV generators and/or the thermal storage units.

The one or more PV generators and/or the one or more thermal storage units may be selected by a server command station to perform control procedures under one or more different modes of operation. In one mode of operation, the one or more PV generators may operate at a maximum power output such that control is constrained only to curtail power output of the one or more PV generators. In one mode of operation, the thermal storage units may operate at a minimum power consumption such that control is constrained only to curtail power consumption of the one or more thermal storage units. The controlling may be applied by a power system operator sending dispatch signals through the server command station to the one or more selected PV generators and/or the one or more thermal storage units.

The method may further comprise reducing utilization of one or more dispatchable peaking generators connected to the mains power grid as a result of the controlling of the power output from the one or more PV generators and/or the controlling of the power consumption in the one or more thermal storage units.

A combined response of the one or more PV generators and the one or more thermal storage units may be utilized to proportionally modify the utilization of the one or more dispatchable peaking generators.

The method may further comprise reducing utilization of one or more batteries connected to the mains power grid as a result of the controlling of the power output from the one or more PV generators and/or the controlling of the power consumption in the one or more thermal storage units.

The method may further comprise reducing a baseload generation of the power mains grid as a result of the controlling of the power output from the one or more PV generators and/or the controlling of the power consumption in the one or more thermal storage units.

The controlling the power output from the one or more PV generators and/or controlling the power consumption in the one or more thermal storage units may be based on supply and demand determinations at one or more selected points of the mains power grid.

The controlling the power consumption in the one or more thermal storage units may be performed such that a temperature of a specific thermal storage unit is maintained to be within a user specified range. A power consumption differential combined among at least two or more thermal storage units responsive to a specific supply and demand event of a selected point of the mains power grid may be quantified among the at least two or more thermal storage units such that a respective user specified range may be satisfied among every thermal storage unit while the power consumption differential is performed.

The method may further comprise selecting a sub-set of the PV generators and/or selecting a sub-set of the thermal storage units and controlling power output from the selected sub-set of PV generators and/or controlling power consumption in the sub-set of thermal storage units responsive to the change in the supply and demand characteristic.

The method may be reactive to predicting or determining intermittency of PV generation in a cloudy day mode.

The method may be reactive to predicting or determining intermittency of PV generation in a sunny day mode.

The method may be reactive to predicting or determining intermittency of PV generation.

The method may further comprise establishing a spinning reserve standby requirement for the mains power grid to maintain one or more dispatch generators connected to the mains power grid with a capacity proportional to a predicted level of intermittency for stability control of the mains power grid.

The characteristic response comprises a frequency response.

The method may be implemented to substantially equalize the supply and demand on at least a portion of the mains power grid.

In one embodiment, a method of determining a characteristic response of a PV generator and/or a characteristic response of a thermal storage unit to establish a control routine for controlling power output from the PV generator and/or for controlling power consumption in the thermal storage unit for substantially equalizing the supply and demand of at least a portion of a mains power grid to which the PV generator and/or the thermal storage units are coupled and/or for substantially equalizing the power output of the one more PV generators and the power consumption of the one or more thermal storage units is provided.

The controlling the power output from one or more PV generators and/or controlling the power consumption in one or more thermal storage units may be responsive to a change in a supply and demand characteristic.

The controlling the power output from one or more PV generators and/or controlling the power consumption in one or more thermal storage units may be based on supply and demand determinations at one or more selected points of the mains power grid.

The characteristic response comprises a frequency response.

In one embodiment, a system for operating a mains power grid is provided, the system comprising a control unit configured for controlling the power output from the one or more photovoltaic (PV) generators coupled to the mains power grid and/or controlling the power consumption in the one or more thermal storage units coupled to the mains power grid based on a characteristic response of the one or more PV generators for curtailment of the power output and a characteristic response of the one or more thermal storage units for curtailment of power consumption.

Each thermal storage unit may comprise a building with one or more associated air conditioners and controlling each thermal storage unit comprises a curtailment of at least one of the one or more associated air conditioners.

The system may be configured to substantially equalize the power output of the one more PV generators and the power consumption of the one or more thermal storage units.

The controlling of the one or more thermal storage units may be responsive to a measured intermittency of selected ones of the one or more PV generators.

The controlling of the one or more PV generators and/or the one or more thermal storage units may be responsive to a change in a supply and demand characteristic of at least a portion of the mains power grid. The system may comprise a determination unit configured for determining the change in the supply and demand characteristic by locally sensing a change in frequency on the mains power grid at respective points of coupling of the PV generators and/or locally at respective points of coupling of the thermal storage units, and locally controlling the PV generators and/or the thermal storage units. The system may comprise a determination unit configured for determining the change in the supply and demand characteristic by sensing a frequency on the mains power grid at respective points of coupling of the PV generators remotely and/or at respective points of coupling of the thermal storage units remotely, and remotely controlling the PV generators and/or the thermal storage units.

The system may further comprise a server command station, wherein the one or more PV generators and/or the one or more thermal storage units are selectable by the server command station to perform control procedures under one or more different modes of operation. In one mode of operation, the one or more PV generators may operate at a maximum power output such that control is constrained only to curtail power output of the one or more PV generators. In one mode of operation, the thermal storage units may operate at a minimum power consumption such that control is constrained only to curtail power consumption of the one or more thermal storage units. The server command station may be configured such that the controlling may be applied by a power system operator sending dispatch signals through the server command station to the one or more selected PV generators and/or the one or more thermal storage units.

The control unit may further be configured for reducing utilization of one or more dispatchable peaking generators connected to the mains power grid as a result of the controlling of the power output from the one or more PV generators and/or the controlling of the power consumption in the one or more thermal storage units. The control unit may be configured such that a combined response of the one or more PV generators and the one or more thermal storage units is utilizable to proportionally modify the utilization of the one or more dispatchable peaking generators.

The control unit may further be configured for reducing utilization of one or more batteries connected to the mains power grid as a result of the controlling of the power output from the one or more PV generators and/or the controlling of the power consumption in the one or more thermal storage units.

The control unit may further be configured for reducing a baseload generation of the power mains grid as a result of the controlling of the power output from the one or more PV generators and/or the controlling of the power consumption in the one or more thermal storage units.

The controlling the power output from the one or more PV generators and/or controlling the power consumption in the one or more thermal storage units may be based on supply and demand determinations at one or more selected points of the mains power grid.

The controlling the power consumption in the one or more thermal storage units may be performed such that a temperature of a specific thermal storage unit is maintained to be within a user specified range. A power consumption differential combined among at least two or more thermal storage units responsive to a specific supply and demand event of a selected point of the mains power grid may be quantifyable among the at least two or more thermal storage units such that a respective user specified range is satisfyable among every thermal storage unit while the power consumption differential is performed.

The control unit may further be configured for selecting a sub-set of the PV generators and/or selecting a sub-set of the thermal storage units and controlling power output from the selected sub-set of PV generators and/or controlling power consumption in the sub-set of thermal storage units responsive to the change in the supply and demand characteristic.

The system may be reactive to predicting or determining intermittency of PV generation in a cloudy day mode.

The system may be reactive to predicting or determining intermittency of PV generation in a sunny day mode.

The system may be reactive to predicting or determining intermittency of PV generation.

The control unit may be further configured for establishing a spinning reserve standby requirement for the mains power grid to maintain one or more dispatch generators connected to the mains power grid with a capacity proportional to a predicted level of intermittency for stability control of the mains power grid.

The characteristic response may comprise a frequency response.

The system may be implemented to substantially equalize the supply and demand on at least a portion of the mains power grid.

In one embodiment, a system for determining a characteristic response of a PV generator and/or a characteristic response of a thermal storage unit to establish a control routine for controlling power output from the PV generator and/or for controlling power consumption in the thermal storage unit for substantially equalizing the supply and demand of at least a portion of a mains power grid to which the PV generator and/or the thermal storage units are coupled and/or for substantially equalizing the power output of the one more PV generators and the power consumption of the one or more thermal storage units is provided.

The controlling the power output from one or more PV generators and/or controlling the power consumption in one or more thermal storage units may be responsive to a change in a supply and demand characteristic.

The controlling the power output from one or more PV generators and/or controlling the power consumption in one or more thermal storage units may be based on supply and demand determinations at one or more selected points of the mains power grid.

The characteristic response may comprise a frequency response.

Artificial intelligence may in addition be utilized in example embodiments among all combined elements, the PV generator, thermal HVAC element, and the synchronous generator (or spinning reserve) so that a merit function accounting for the most appropriate amount of electrical supply and demand can be achieved.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive. Also, the invention includes any combination of features, in particular any combination of features in the patent claims, even if the feature or combination of features is not explicitly specified in the patent claims or the present embodiments.

The various functions or processes disclosed herein may be described as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the internet and/or other computer networks via one or more data transfer protocols (e.g., HTTP, FTP, SMTP, etc.). When received within a computer system via one or more computer-readable media, such data and/or instruction-based expressions of components and/or processes under the system described may be processed by a processing entity (e.g., one or more processors) within the computer system in conjunction with execution of one or more other computer programs.

Aspects of the systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the system include: microcontrollers with memory (such as electronically erasable programmable read only memory (EEPROM)), embedded microprocessors, firmware, software, etc. Furthermore, aspects of the system may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the systems and methods is not intended to be exhaustive or to limit the systems and methods to the precise forms disclosed. While specific embodiments of, and examples for, the systems components and methods are described herein for illustrative purposes, various equivalent modifications are possible within the scope of the systems, components and methods, as those skilled in the relevant art will recognize. The teachings of the systems and methods provided herein can be applied to other processing systems and methods, not only for the systems and methods described above.

The elements and acts of the various embodiments described above can be combined to provide further embodiments. These and other changes can be made to the systems and methods in light of the above detailed description.

In general, in the following claims, the terms used should not be construed to limit the systems and methods to the specific embodiments disclosed in the specification and the claims, but should be construed to include all processing systems that operate under the claims. Accordingly, the systems and methods are not limited by the disclosure, but instead the scope of the systems and methods is to be determined entirely by the claims.

1. A method for operating a mains power grid, the method comprising controlling a power output from one or more photovoltaic (PV) generators coupled to the mains power grid and/or controlling power consumption in one or more thermal storage units coupled to the mains power grid based on a characteristic response of the one or more PV generators for curtailment of the power output and a characteristic response of the one or more thermal storage units for curtailment of power consumption.

2. The method of claim 1, wherein each thermal storage unit comprises a building with one or more associated air conditioners and controlling each thermal storage unit comprises a curtailment of at least one of the one or more associated air conditioners.

3. The method of claim 1, wherein the method is implemented to substantially equalize the power output of the one more PV generators and the power consumption of the one or more thermal storage units.

4. The method of claim 1, wherein the controlling of the one or more thermal storage units is responsive to a measured intermittency of selected ones of the one or more PV generators.

5.-16. (canceled)

17. The method of claim 1, wherein the controlling the power consumption in the one or more thermal storage units is performed such that a temperature of a specific thermal storage unit is maintained to be within a user specified range, and wherein a power consumption differential combined among at least two or more thermal storage units responsive to a specific supply and demand event of a selected point of the mains power grid is quantified among the at least two or more thermal storage units such that a respective user specified range is satisfied among every thermal storage unit while the power consumption differential is performed.

18.-23. (canceled)

24. A method of determining a characteristic response of a PV generator and/or a characteristic response of a thermal storage unit to establish a control routine for controlling power output from the PV generator and/or for controlling power consumption in the thermal storage unit for substantially equalizing the supply and demand of at least a portion of a mains power grid to which the PV generator and/or the thermal storage units are coupled, and/or for substantially equalizing the power output of the one more PV generators and the power consumption of the one or more thermal storage units.

25. The method of claim 24, wherein the controlling the power output from one or more PV generators and/or controlling the power consumption in one or more thermal storage units is responsive to a change in a supply and demand characteristic.

26. The method of claim 24, wherein the controlling the power output from one or more PV generators and/or controlling the power consumption in one or more thermal storage units is based on supply and demand determinations at one or more selected points of the mains power grid.

27. The method of claim 24, wherein the characteristic response comprises a frequency response.

28. A system for operating a mains power grid, the system comprising a control unit configured for controlling a power output from one or more photovoltaic (PV) generators coupled to the mains power grid and/or controlling power consumption in one or more thermal storage units coupled to the mains power grid based on a characteristic response of the one or more PV generators for curtailment of the power output and a characteristic response of the one or more thermal storage units for curtailment of power consumption.

29. The system of claim 28, wherein each thermal storage unit comprises a building with one or more associated air conditioners and controlling each thermal storage unit comprises a curtailment of at least one of the one or more associated air conditioners.

30. The system of claim 28, wherein the system configured to substantially equalize the power output of the one more PV generators and the power consumption of the one or more thermal storage units.

31. The system of claim 28, wherein the controlling of the one or more thermal storage units is responsive to a measured intermittency of selected ones of the one or more PV generators.

32.-43. (canceled)

44. The system of claim 28, wherein the controlling the power consumption in the one or more thermal storage units is performed such that a temperature of a specific thermal storage unit is maintained to be within a user specified range, and wherein a power consumption differential combined among at least two or more thermal storage units responsive to a specific supply and demand event of a selected point of the mains power grid is quantifyable among the at least two or more thermal storage units such that a respective user specified range is satisfyable among every thermal storage unit while the power consumption differential is performed.

45.-50. (canceled)

51. A system for determining a characteristic response of a PV generator and/or a characteristic response of a thermal storage unit to establish a control routine for controlling power output from the PV generator and/or for controlling power consumption in the thermal storage unit for substantially equalizing the supply and demand of at least a portion of a mains power grid to which the PV generator and/or the thermal storage units are coupled, and/or for substantially equalizing the power output of the one more PV generators and the power consumption of the one or more thermal storage units.

52. The system of claim 51, wherein controlling the power output from one or more PV generators and/or controlling the power consumption in one or more thermal storage units is responsive to a change in a supply and demand characteristic.

53. The system of claim 51, wherein controlling the power output from one or more PV generators and/or controlling the power consumption in one or more thermal storage units is based on supply and demand determinations at one or more selected points of the mains power grid.

54. The system of claim 51, wherein the characteristic response comprises a frequency response.

55.-56. (canceled)

57. The system of claim 28, wherein the characteristic response comprises a frequency response.

58. The method of claim 1, wherein the characteristic response comprises a frequency response.
